(19) United States
(12) Patent Application Publication
(10) Pub. No.: US 2015/0007068 A1
(43) Pub. Date: Jan. 1, 2015

(54) DASHBOARD WITH LIVE PREVIEW

(71) Applicant: Antivia Group Limited, Gerrards Cross (GB)

(72) Inventors: Jason Lilley, Leeds (GB); Paul Vallender, Leeds (GB)

(73) Assignee: Antivia Group Limited, Leeds (GB)

(21) Appl. No.: 14/320,117

(22) Filed: Jun. 30, 2014

Related U.S. Application Data
(60) Provisional application No. 61/856,230, filed on Jul. 19, 2013.

(30) Foreign Application Priority Data
Jul. 1, 2013 (GB) 1311778.3

(51) Int. Cl. G06F 3/0481; G06Q 10/06; H04L 29/08

(52) U.S. Cl. CPC G06F 3/0481; H04L 67/10; G06Q 10/0631
USPC 715/762

(57) ABSTRACT

This invention relates to a system and method for creation and deployment of client specific, dynamic, interactive dashboards to access business intelligence. More particularly, the present invention relates to a system for creation of a client specific, dynamic, web interactive dashboards to access business intelligence providing live preview on multiple platforms throughout development of the dashboard. The method for providing live preview of a business dashboard, includes using a design tool running on a first computer to create a dashboard and to render the dashboard on a display of the first computer. The first computer then establishes communication between the design tool on the first computer and at least one remote target device, such as a smart phone or tablet computer. The design tool then communicates instructions to enable the at least one remote target device to render the dashboard natively on a remote target device display of the at least one target device and the dashboard is operable directly on the remote target device independently of the first computer. Changes to the dashboard implemented by the design tool at the first computer are communicated to the remote target device substantially in real time to effect the same design changes to the dashboard rendered on the remote target device display.

### CROSS REFERENCE TO RELATED APPLICATIONS

This application claims priority of U.S. Provisional Patent Application Ser. No. 61/856,230, filed 19 Jul. 2013.

This application also claims priority of United Kingdom patent application GB 1311778.3 filed 1 Jul. 2013.

Both of the above applications are incorporated herein by reference and priority of both is hereby claimed.

### BRIEF SUMMARY OF THE DISCLOSURE

This invention relates to a method and system for creation and deployment of client specific, dynamic, interactive dashboards to access business intelligence. More particularly, the present invention relates to a method and system for creation of a client specific, dynamic, web interactive business dashboards to access business intelligence providing live preview on multiple target devices throughout development of the dashboard.

The reason for implementing business intelligence is to help business people make better, fact-based decisions. Business intelligence (BI) is a set of theories, methodologies, processes, architectures, and technologies that transform raw data into meaningful and useful information for business purposes. BI can handle large amounts of information to help identify and develop new opportunities. Making use of new opportunities and implementing an effective strategy can provide a competitive market advantage and long-term stability.

Interactive dashboards provide a convenient starting point for accessing business intelligence. Interactive dashboards are an evolution of the original at-a-glance dashboards that provided static, at-a-glance view of business information. End-users now expect more capabilities from their dashboards. In particular, when an end-user spots an anomaly with one of their figures, they want to understand how that number is constituted by drilling into lower levels of detail, to ultimately help them make better-informed decisions.

Interactive dashboards can present key information in a visually compelling manner, for rapid assimilation, whilst supporting drill-down to lower levels of detail to enable users to investigate anomalies. Interactive dashboard tools enable designers to implement workflows that reflect an organisation's underlying business process, resulting in intuitive, zero-training required interfaces, rather than relying on users to make do with packaged reporting or to struggle with generic data discovery tools with highly non-trivial interfaces. Controlled flexibility of interactive dashboards allows them to get different views of the data to answer their 2nd and 3rd level questions, without needing to go back to the BI team.

Businesses are global and often the decision makers are spread across different sites and in different continents. Development of interactive dashboards can therefore be very slow, requiring numerous iterations of review and authorisation. This is time consuming and creates inefficiencies and set-backs in implementation of the dashboards.

In accordance with a first aspect, there is provided a method for providing live preview of a business dashboard, the method comprising:

using a design tool running on a first computer to create a dashboard and to render the dashboard on a display of the first computer;

establishing communication between the design tool on the first computer and at least one remote target device;

the design tool communicating instructions to enable the at least one remote target device to render the dashboard natively on a remote target device display of the at least one remote target device, the dashboard being operable directly on the remote target device independently of the first computer;

wherein design changes to the dashboard implemented by the design tool at the first computer are communicated to the remote target device substantially in real time to effect the same design changes to the dashboard rendered on the remote target device display.

In accordance with a second aspect, there is provided a method for providing live preview of a business dashboard on a target device, the method comprising:

receiving a communication request from a design tool running on a remote first computer and establishing communication between the target device and the design tool;

receiving instructions from the design tool to cause the target device natively to render the dashboard on display of the remote target device, the dashboard being operable directly on the target device independently of the remote first computer;

receiving design changes to the dashboard implemented by the design tool at the first computer substantially in real time to effect the same design changes to the dashboard rendered on the target device display.

In accordance with a third aspect, there is provided a business dashboard system, the system comprising:

a design tool operable on a first computer to create a dashboard and render the dashboard on a display of the first computer; wherein

the first computer is configured to establish communication between the design tool and at least one target device;

the design tool is configured to communicate instructions to enable the at least one target device to render a dashboard natively on a target device display of the at least one target device, the dashboard being operable directly on the target device independently of the first computer; and

the design tool is configured to communicate changes to the dashboard implemented by the design tool at the first computer to the target device substantially in real time to effect the same design changes to the dashboard rendered on the target device display.

In accordance with a fourth aspect, there is provided a business dashboard system, the system comprising:

at least one target device; and

a design tool operable on a first computer to create a dashboard and render the dashboard on a display of the first computer; wherein

the first computer is configured to establish communication between the design tool and at least one target device;

the design tool is configured to communicate instructions to enable the at least one target device to render a dashboard natively on a target device display of the at least one target device, the dashboard being operable directly on the target device independently of the first computer; and

the design tool is configured to communicate changes to the dashboard implemented by the design tool at the first computer to the target device substantially in real time to effect the same design changes to the dashboard rendered on the target device display.

The method and system for live preview of a business dashboard seek to overcome issues that arise when designing business dashboards for a variety of target devices such as tablet computers, Blackberry® devices, smartphones, or desktop computers. Such devices typically have different display capabilities and different general hardware performance. The method and system enables the user of the design tool to instantly render the business dashboard on one or more remote target devices and to update the dashboard on the remote target device in substantially real time. Substantially real time display of the business dashboard aids collaboration with the end users.

Furthermore, the end user can observe the dashboard being built in real time, and provide feedback to the designer in real time.

Substantially real time display of the business dashboard on a variety of different devices aids the productivity of business dashboard designers, since they can easily observe the business dashboard as rendered and viewed on different device displays.

Preferably, the target device or the remote target device may be configured to communicate design changes to the design tool.

Preferably, the remote target devices may be configured to feed back information to the design tool during the development stage of the dashboard. The updated model of the dashboard from the remote target device may propagate though all the remote target devices and the design tool.

The remote target device may itself run an implementation of the design tool.

Indeed, in certain embodiments, the first computer and at least one, optionally more, remote target devices each serve as a node, running an implementation of the design tool. Each implementation of the design tool is preferably configured to be able to render data independently of the other implementations, but is configurable such that a design change made with one design tool may be propagated to all of the other implementations of the design tool. This allows truly collaborative working.

Preferably, the method and system may be further provided with a design tool able to provide multiplatform functionality such that multiple varied target devices can render their own copy of the dashboard in real time, as the dashboard is being developed. The design tool operated on a first computer is able to communicate instructions to assist the remote target device to render the dashboard in a format suitable for the platform of the remote target device.

The design tool may be adapted to incorporate the user's information into the first model of the dashboard, and render a subsequent model of the dashboard.

A benefit of the method and system is that the user of the design tool can instantly see how the changes to the model of the dashboard are rendered and how the model of the dashboard performs on different target devices. Target device users can actively participate with the overall design of the dashboard in real time.

The dashboard may be adapted to connect directly to data sources, such as remote or local servers. On receiving a request from the dashboard, the data sources may feed information directly to the dashboard on both the first computer and the target device. This enables real time development of instantly useable business dashboards and negates the necessity for compiling documents, sending documents, and loading documents.

### BRIEF DESCRIPTION OF THE DRAWINGS

Embodiments of the invention are further described hereinafter with reference to the accompanying drawings, in which:

FIG. 1 shows the relationship between the design tool and the target device;

FIG. 2 shows a flow diagram of lifecycle between the design tool and a single target device.

### DETAILED DESCRIPTION

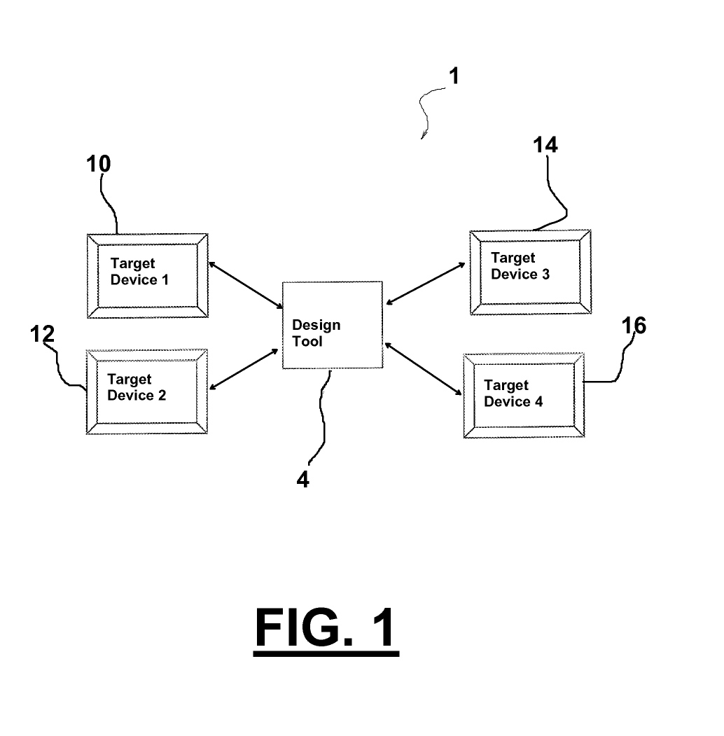

The method and system 1 for providing live preview of a business dashboard includes a design tool 4 operating on a first computer, in communication with remote target devices 10, 12, 14, 16 as shown in FIG. 1.

The remote target devices typically have different display capabilities and different general hardware performance. Therefore, remote target devices such as tablet computers, Blackberry® devices, smartphones, or desktop computers requiring different rendering instructions are able to display a business dashboard appropriately on the display of the remote target device.

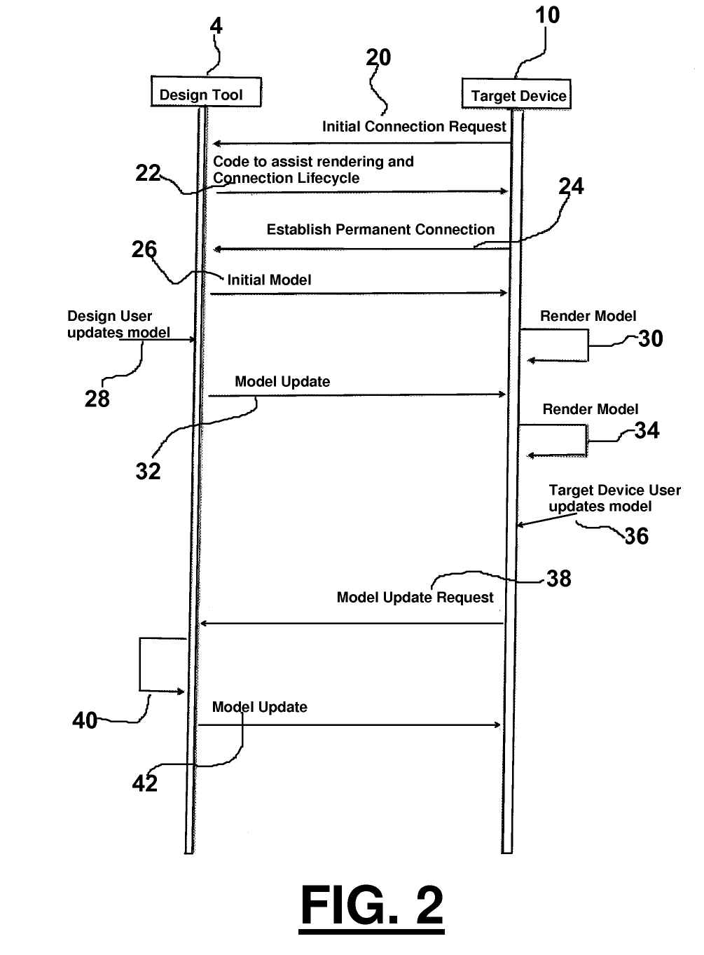

FIG. 2 shows a flow diagram of the typical lifecycle between the design tool and a single target device. The design tool 4 operated on a first computer (not shown) provides functionality for the end-user to build business intelligence dashboards and applications. The unique function of the design tool is that it allows multiple remote target devices to simultaneously connect using established network protocols to the design tool.

The first computer establishes an initial connection between the design tool 4 and the remote target device 10 by making an initial connection request 20.

The design tool communicates suitable code 22 and connection life cycle to the target device 10 such that the target device 10 can render the business dashboard. The business dashboard, as displayed on the display of the target device can connect to data-sources that directly feed information into the business dashboard and allow the target device to receive further instruction from the design tool by the target device establishing a connection 24 that remains established for the duration of the live preview session with the design tool.

The design tool communicates a first (or initial) model 26 of the dashboard. The model defines the dashboard.

The target device then uses the code and renders the initial model 30 of the dashboard on the display of the target device. The dashboard as displayed on the target device, and the dashboard enables the target device user to access all the data within the dashboard through suitable connection to the data sources.

Both the design tool on the first computer and the target device can access the stored data. The target device or the design tool make a request to retrieve information from the data sources using well established internet protocols. The information to access the data sources is provided within the model of the dashboard.

Data sources may be stored in a user's local or remote server accessed via network protocols.

The design tool 4 communicates updated instructions to the target device 10. The updated instructions reflect changes that the user of the design tool 4 is making to the current model of the dashboard, as displayed on the display of the first computer.

The target device 10 renders the updated model of the dashboard 34 using code 22 provided by the design tool. Several design update/rendering steps may be completed before the dashboard is finalised. However, throughout the design process, the target device user is able to operate the dashboard on their device independently of the first computer.

The user of the target device may additionally provide updates 36 to the dashboard. The user of the target device 10 sends updates of the model of the dashboard to the design tool 4. Multiple users of target devices may simultaneously send updated models of the business dashboards. The updates propagate through all connected target devices and the design tool.

The target device will therefore request a model update 38 from the design tool. The design tool will then acknowledge the request and if desired accept the remote update request 40. The design tool will then send an updated model for the dashboard to the remote target device 10 and the remote target device will render the updated model and display the updated dashboard.

In this manner, the target devices are operable to run an implementation of the design tool, each target device being able to provide updates to the design tool operable on the first computer. The updates are subsequently authorised by the design tool operable on the first computer and an updated model of the dashboard is communicated to the target devices.

Alternatively, the design tool 4 operated on a first computer (not shown) can provide functionality for the end-user to build mobile applications where a feedback loop between a user of a remote target device may be beneficial to efficiently designing the mobile applications.

It will be clear to a person skilled in the art that features described in relation to any of the embodiments described above can be applicable interchangeably between the different embodiments. The embodiments described above are examples to illustrate various features of the invention

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method for providing live preview of a business dashboard, the method comprising:
using a design tool running on a first computer to create a dashboard and to render the dashboard on a display of the first computer;
establishing communication between the design tool on the first computer and at least one remote target device;
the design tool communicating instructions to enable the at least one remote target device to render the dashboard natively on a remote target device display of the at least one remote target device, the dashboard being operable directly on the remote target device independently of the first computer;
wherein design changes to the dashboard implemented by the design tool at the first computer are communicated to the remote target device substantially in real time to effect the same design changes to the dashboard rendered on the remote target device display.

2. A method for providing live preview of a business dashboard on a target device, the method comprising:
receiving a communication request from a design tool running on a remote first computer and establishing communication between the target device and the design tool;
receiving instructions from the design tool to cause the target device natively to render the dashboard on display of the remote target device, the dashboard being operable directly on the target device independently of the remote first computer;
receiving design changes to the dashboard implemented by the design tool at the first computer substantially in real time to effect the same design changes to the dashboard rendered on the target device display.

3. A business dashboard system, the system comprising:
a design tool operable on a first computer to create a dashboard and render the dashboard on a display of the first computer; wherein the first computer is configured to establish communication between the design tool and at least one target device;
the design tool is configured to communicate instructions to enable the at least one target device to render a dashboard natively on a target device display of the at least one target device, the dashboard being operable directly on the target device independently of the first computer; and
the design tool is configured to communicate changes to the dashboard implemented by the design tool at the first computer to the target device substantially in real time to effect the same design changes to the dashboard rendered on the target device display.

4. A business dashboard system, the system comprising:
at least one target device; and
a design tool operable on a first computer to create a dashboard and render the dashboard on a display of the first computer; wherein
the first computer is configured to establish communication between the design tool and at least one target device;
the design tool is configured to communicate instructions to enable the at least one target device to render a dashboard natively on a target device display of the at least one target device, the dashboard being operable directly on the target device independently of the first computer; and
the design tool is configured to communicate changes to the dashboard implemented by the design tool at the first computer to the target device substantially in real time to effect the same design changes to the dashboard rendered on the target device display.

5. The method according to claim 1, wherein the target device communicates design changes to the design tool.

6. The method according to claim 1 wherein the target device runs an implementation of the design tool.

7. The method according to claim 6, wherein the target device renders data independently of the other implementations of the design tool.

8. The business dashboard system according to claim 3, wherein the target device is configured to communicate design changes to the design tool.

9. The business dashboard system according to claim 3 wherein the target device is configured to run an implementation of the design tool.

10. The business dashboard system according to claim 9, wherein the target device is configured to be able to render data independently of the other implementations of the design tool.

11-12. (canceled)

13. The method according to claim 2, wherein the target device communicates design changes to the design tool.

14. The method according to claim 2, wherein the target device runs an implementation of the design tool.

15. The method according to claim 5, wherein the target device runs an implementation of the design tool.

16. The business dashboard system according to claim 4, wherein the target device is configured to communicate design changes to the design tool.

17. The business dashboard system according to claim 4, wherein the target device is configured to run an implementation of the design tool.

18. The business dashboard system according to claim 8, wherein the target device is configured to run an implementation of the design tool.
